(19) United States
(12) Patent Application Publication
(10) Pub. No.: US 2014/0069390 A1
(43) Pub. Date: Mar. 13, 2014

(54) FUEL INJECTION CONTROLLER

(71) Applicant: Denso Corporation, Kariya-city (JP)

(72) Inventors: Toshio NISHIMURA, Anjo-city (JP); Takayoshi HONDA, Nagoya-city (JP)

(73) Assignee: DENSO CORPORATION, Kariya-city (JP)

(21) Appl. No.: 14/013,695

(22) Filed: Aug. 29, 2013

(30) Foreign Application Priority Data
Sep. 13, 2012 (JP) 2012-202005

(51) Int. Cl. F02D 41/30

(52) U.S. Cl. CPC F02D 41/30
USPC 123/478

(57) ABSTRACT

A fuel injection controller supplies a valve-opening voltage VF1 to a fuel injector. In order to obtain a small injection quantity, the controller terminates a supply of the valve-opening voltage before the fuel injector is fully opened. A bias-control portion supplies a bias voltage to the fuel injector instead of the valve-opening voltage. A valve-close detecting portion detects a valve-closing time by detecting an inflection point on a waveform of an electric current flowing through the coil. A correction-amount computing portion computes a correction amount based on the detected valve-closing time. A correction portion corrects an electric supply period based on the correction amount.

### CROSS-REFERENCE TO RELATED APPLICATION

This application is based on Japanese Patent Application No. 2012-202005 filed on Sep. 13, 2012, the disclosure of which is incorporated herein by reference.

### TECHNICAL FIELD

The present disclosure relates to a fuel injection controller which controls a fuel injector.

### BACKGROUND

JP-2010-532448A and JP-2010-73705A disclose a method for detecting a position of a needle of an electromagnetic valve, such as a fuel injector. Especially, JP-2010-532448A discloses a method for detecting a valve-closing time of a fuel injector.

A fuel injection quantity of a fuel injector is adjusted by controlling a valve opening period of the fuel injector. In order to obtain small injection quantity, it is necessary to shorten the valve opening period of the fuel injector. However, in the small injection quantity, an error of injection quantity is significant. Thus, an accurate injection quantity control is difficult. For example, the error of fuel injection quantity is generated by various factors, such as an error of the mechanical shape of a fuel injector, an error of electric current, and an error of voltage.

In order to obtain small injection quantity, further improvements are necessary in a fuel injection controller.

### SUMMARY

It is an object of the present disclosure to provide a fuel injection controller which is able to detect that a fuel injector is fully closed even when a valve-opening voltage is stopped before the fuel injector is fully opened. The fuel injection controller can obtain small injection quantity correctly.

A fuel injection controller has terminals connectable to a coil of a fuel injector. The fuel injection controller has a valve-open control portion which supplies a valve-opening voltage to the terminals for opening the fuel injector and terminates the supply of the valve-opening voltage before the fuel injector is fully opened. Further, the fuel injection controller has a valve-close detecting portion which detects that the fuel injector is fully closed by detecting an inflection point on a waveform of an electric current flowing through the coil or an inflection point on a waveform of a voltage applied to the terminals.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing an internal combustion engine system according to a first embodiment;

FIG. 2 is a circuit diagram of a driving circuit according to the first embodiment;

FIG. 3 is a flowchart illustrating a control processing according to the first embodiment; and

FIG. 4 is a time chart showing an operation according to the first embodiment.

FIG. 5 is a flowchart illustrating a control processing according to a second embodiment;

FIG. 6 is a time chart showing an operation according to the second embodiment;

FIG. 7 is a flowchart illustrating a control processing according to a third embodiment;

FIG. 8 is a time chart showing an operation according to the third embodiment;

FIG. 9 is a flowchart illustrating a control processing according to a fourth embodiment;

FIG. 10 is a time chart showing an operation according to the fourth embodiment;

FIG. 11 is a circuit diagram of a driving circuit according to a fifth embodiment;

FIG. 12 is a flowchart illustrating a control processing according to the fifth embodiment;

FIG. 13 is a time chart showing an operation according to the fifth embodiment; and

FIG. 14 is a time chart showing an operation according to a sixth embodiment;

### DETAILED DESCRIPTION

Referring to drawings, embodiments of the present disclosure will be described hereinafter. In these embodiments, the same parts and components as those in each embodiment are indicated with the same reference numerals and the same descriptions will not be reiterated.

### First Embodiment

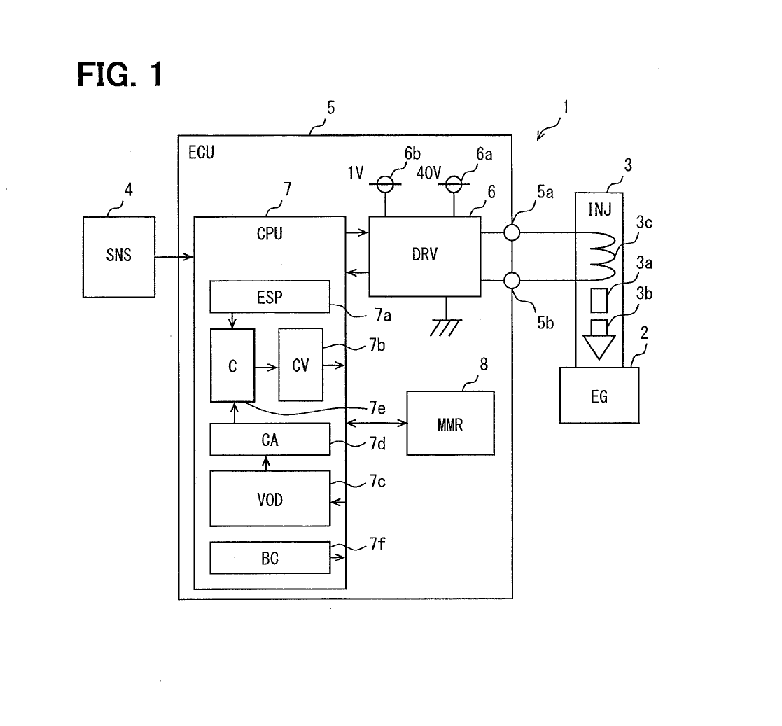

FIG. 1 shows an internal combustion engine system 1 according to a first embodiment. The internal combustion engine system 1 is provided with an internal combustion engine 2 for a vehicle. The internal combustion engine system 1 is provided with a fuel supply system for supplying a fuel to the internal combustion engine 2. The fuel supply system is comprised of a fuel injector (INJ) 3, multiple sensors (SNS) 4, and a fuel injection controller (ECU) 5.

The fuel injector 3 is a normally-closed type solenoid valve. The fuel injector 3 receives pressurized fuel from a fuel pump (not shown). When the fuel injector 3 is opened, the pressurized fuel is injected into the internal combustion engine 2. The fuel injector 3 is arranged in an intake passage of the internal combustion engine 2. In this case, the fuel injector 3 injects a fuel towards an intake air to form air-fuel mixture. Alternatively, the fuel injector 3 is arranged in a cylinder head of the internal combustion engine 2. In this case, the fuel injector 3 injects a fuel towards a combustion chamber.

The fuel injector 3 is comprised of a stator 3a including a fixed core, a needle 3b including a movable valve and a movable core, and a coil 3c for magnetizing the stator 3a. The coil 3c is a magnetic coil. When the coil 3c is energized, the needle 3b is magnetically attracted toward the stator 3a. The needle 3b is biased in a valve-closing direction by a spring (not shown).

When the coil 3c is not energized, the needle 3b is biased in a valve-closing direction. Therefore, when the coil 3c is not energized, the fuel injector 3 injects no fuel. When the coil 3c is energized, the needle 3b is magnetically attracted toward the stator 3a. The fuel injector 3 is opened to inject the fuel. There is a specified time delay from when the coil 3c is energized until when the fuel injector 3 is opened. When the coil 3c is deenergized, the fuel injector 3 is closed to stop the fuel injection. There is a specified time delay from when the coil 3c is deenergized until when the fuel injector 3 is closed.

The sensors 4 include an accelerator sensor, an engine speed sensor, and an intake-air sensor detecting an intake air quantity.

The fuel injection controller 5 is an electronic control unit (ECU). The ECU 5 has terminals 5a and 5b which can be connected to the coil 3c of the fuel injector 3. The ECU 5 is provided with a drive circuit (DRV) 6 which controls the voltage supplied to the coil 3c and the electric current flowing into the coil 3c. The drive circuit 6 has a high voltage supply 6a for driving the fuel injector 3 at high speed.

The high voltage supply 6a is connected to a booster circuit which boosts a battery voltage. The voltage “VF1” of the high voltage supply 6a is 40V. The drive circuit 6 has a low voltage supply 6b which supplies a bias voltage for observing a waveform of the voltage which appears on both ends of the coil 3c, or a waveform of the electric current flowing through the coil 3c. The Voltage “VF2” of the low voltage supply 6b is lower than the voltage “VF1” of the high voltage supply 6a. The voltage “VF2” of the low voltage supply 6b is 1V (one volt).

The ECU 5 has a processing unit (CPU) 7 and a memory (MMR) 8 in which programs are stored. The ECU 5 is a microcomputer having a memory media. The memory media stores various programs which the computer executes. The memory media is a semiconductor memory or a magnetic disc.

The CPU 7 executes the programs stored in the memory 8 to perform a control of the fuel injector 3. The CPU 7 has a plurality of control portions.

The injection control unit determines a valve-opening period of the fuel injector 3 in order to adjust the fuel injection quantity. The fuel injection quantity can be adjusted from a small injection quantity to a normal injection quantity. The small injection quantity is obtained by stopping a supply of the valve-opening voltage before the fuel injector 3 reaches the full-open position from the full-close position. The normal injection quantity is obtained by stopping a supply of the valve-opening voltage after the fuel injector 3 reaches the full-open position.

The CPU 7 has an electric-supply-period computing portion 7a. The electric-supply-period computing portion 7a determines an electric supply period “TS” during which the valve-opening voltage is applied to the fuel injector 3 to be opened. A valve-open-delay period “TL” is subtracted from the electric supply period “TS”. Then, a valve-close-delay period “TT” is added to obtain a valve-opening period of the fuel injector 3. Thus, the electric supply period “TS” is equivalent to the target small fuel injection quantity “Q”. The electric supply period “TS” is defined in such a manner that the supply of the valve-opening voltage is stopped before the fuel injector 3 reaches the full-open position from the full-close position.

The CPU 7 has a valve-open control portion 7b. The valve-open control portion 7b supplies a valve-opening voltage to the terminals 5a, 5b. Then, after a specified period has elapsed, the valve-open control portion 7b stops supplying the valve-opening voltage to the terminals 5a, 5b. The valve-open control portion 7b may stop supplying the electric supply to the coil 3c before the fuel injector 3 is positioned at a full-open position. Also, the valve-open control portion 7b may stop supplying the electric supply to the coil 3c after the fuel injector 3 is positioned at a full-open position.

The valve-open control portion 7b controls the drive circuit 6 in such a manner that the high voltage supply 6a intermittently supplies the electricity to the coil 3c. Therefore, the valve-opening voltage is “VF1” (+40V). The valve-opening voltage “VF1” is supplied to the coil 3c and magnetizing current flows. The valve-open control portion 7b moves the needle 3b in a valve-opening direction.

The valve-open control portion 7b has a stop circuit for maintaining the fuel injector 3 at the full-close position. The valve-open control portion 7b changes the voltage supplied to the terminals 5a and 5b to the valve-opening voltage (VF1) in a valve-opening time. When the electric supply period “TS” has elapsed after the valve-opening voltage (VF1) is supplied, the valve-open control portion 7b changes the voltage to the valve-closing voltage. The valve-closing voltage may be the bias voltage (VF2) supplied from the low voltage supply 6b. The valve-closing voltage may be a stopping voltage (zero Volt) of when not driving the fuel injector 3.

The valve-open control portion 7b may perform a demagnetization control in order to quickly attenuate the residual magnetization energy remaining in the coil 3c. The demagnetization control can be performed after the supply of the valve-opening voltage is stopped. For example, the demagnetization control can be performed by a closed circuit including the coil 3c. The closed circuit may have a reverse-direction power source, a switching device and a resistor. The reverse-direction power source can supply a reverse voltage to the coil 3c.

The CPU 7 has a valve-close detecting portion 7c. The valve-close detecting portion 7c detects that the fuel injector 3 is positioned at the full-close position by detecting an inflection point on a waveform of electric current “IL” flowing through the coil 3c or an inflection point on a waveform of the voltage “Ve” at terminals 5a, 5b. The valve-close detecting portion 7c detecting the inflection point on a waveform of reverse voltage “Ve” induced by the coil 3c or the electric current “IL” flowing through the coil 3c. The valve-close detecting portion 7c corresponds to an inflection point detecting portion.

The inductance of the coil 3c is varies according to a position of the needle 3b and its movements. For this reason, the reverse voltage “Ve” and the electric current “IL” are also varied according to the position of the needle 3b. Especially, when the needle 3b is positioned at the full-close position, the waveforms of the reverse voltage “Ve” and the electric current “IL” vary not smoothly. This variation appears on waveforms of the reverse voltage “Ve” and the electric current “IL” as inflection points. The inflection points on the waveform can be detected by mathematical processing. For example, the inflection points are detected by differentiation processing and/or integration processing.

At a time when the inflection point occurs, the fuel injector 3 is at full-close position. That is, it is an actual valve-closing time. The valve-close detecting portion 7c detects an inflection point in a single fuel injection conducted by the detection control portion 7f, whereby an actual valve-closing time of the fuel injection is identified. Therefore, by detecting the inflection point on the waveform of the electric current or voltage in a preceding fuel injection, the valve-closing time of the preceding fuel injection is identified.

The valve-closing time is varied by various factors, such as an error of the mechanical shape of a fuel injector, an error of electric current, an error of voltage and a variation in temperature. Therefore, by detecting the actual valve-closing time, a difference between the valve-closing time and an intended target valve-closing time is obtained. That is, an error of the fuel injection quantity “Q” can be obtained. Furthermore, based on the actual valve-closing time, the electric supply period “TS” can be corrected in such a manner as to obtain the intended fuel injection quantity “Q”.

The CPU 7 has a correction-amount computing portion 7d. Based on the actual valve-closing time in the preceding fuel injection, the correction-amount computing portion 7d computes a correction amount “Te” of the electric supply period “TS” in a succeeding fuel injection. When the valve-closing time in the preceding fuel injection is earlier than the target valve-closing time, the correction amount “Te” is established to increase the electric supply period “TS” in the succeeding fuel injection. When the actual valve-closing time in the preceding fuel injection is later than the target valve-closing time, the correction amount “Te” is established to decrease the electric supply period “TS” in the succeeding fuel injection.

The CPU 7 has a correction portion 7e. The correction portion 7e corrects at least one of the electric supply period “TS” which the electric-supply-period computing portion 7a establishes based on the correction amount “Te” and a parameter for valve-close controlling by the valve-open control portion 7b.

In the present embodiment, in the correcting processing, a valve-opening period in a preceding fuel injection is obtained. The valve-opening period is a time period from when the valve-opening voltage “VF1” is supplied until when the fuel injector 3 is fully closed (valve-closing time). This valve-opening period is expressed by a rotation angle of the internal combustion engine 2. Based on the valve-opening period of the preceding fuel injection, the electric supply period “TS” in succeeding fuel injection is corrected. The valve-opening period in following fuel injection becomes a target valve-opening period. The target valve-opening period may have an allowable range.

In another correcting processing, a valve-close-delay period in a preceding fuel injection is obtained. The valve-close-delay period is a period from when the valve-opening voltage “VF1” is stopped until the valve-closing time. Based on the valve-close-delay period of the preceding fuel injection, the electric supply period “TS” in succeeding fuel injection is corrected. The valve-close-delay period in following fuel injection becomes a target valve-close-delay period. The target valve-close-delay period may have an allowable range.

When the electric supply period “TS” has passed after the voltage supplied to the terminals 5a, 5b is changed to the valve-opening voltage “VF1”, the voltage supplied to the terminals 5a, 5b may be changed into a voltage equivalent to a release position (OPEN) or a short condition (GND). In this case, the valve-opening period is a period from when the valve-opening voltage “VF1” is supplied until the valve-closing time. The valve-close-delay period is a period from when the stopping voltage (0V) is supplied until the valve-closing time.

When the electric supply period “TS” has passed after the voltage supplied to the terminals 5a, 5b is changed to the valve-opening voltage “VF1”, the voltage supplied to the terminals 5a, 5b may be changed into a bias voltage “VF2”. The valve-opening period is a period from when the valve-opening voltage “VF1” is supplied until the valve-closing time. The valve-close-delay period is a period from when the bias voltage “VF2” is supplied until the valve-closing time.

A correction-amount computing portion 7d and a correction portion 7e correct the parameter in succeeding fuel injection so that an error of the fuel injection quantity resulting from the error of the valve-closing time in succeeding fuel injection and the target valve-closing time may be decreased based on the valve-closing time detected in the preceding fuel injection. The parameter is the electric supply period “TS”, for example. Therefore, the target valve-closing time is obtained correctly, and the small injection quantity is obtained correctly.

The CPU 7 has a bias-control portion 7 which supplies bias voltage to the terminals 5a, 5b. The waveforms of the reverse voltage “Ve” and the electric current “IL” are easily observed from the bias voltage. The value of the bias voltage is established in such a manner that a clear inflection point appears on the waveform of electric current “IL” or the reverse voltage “Ve”. The bias voltage is low voltage which does not drive the fuel injector 3 in a valve opening direction.

The bias-control portion 7f supplies the bias voltage to an injector which the valve-close detecting portion 7c will detect the valve-closing time. Therefore, the bias-control portion 7f and the valve-close detecting portion 7c operate synchronously.

The valve-close detecting portion 7c and the bias-control portion 7f perform a valve-close detecting processing for detecting the valve-closing time. The valve-close detecting portion 7c, the bias-control portion 7f, and the correction-amount computing portion 7d perform a correction-establishing processing in which a correction amount is newly established. The valve-close detecting processing or the correction-establishing processing can be performed with respect to all fuel injection or a part of fuel injections. Specifically, the valve-close detecting processing or the correction-establishing processing can be performed periodically. Moreover, a valve-close detecting processing or the correction-establishing processing can be performed according to the engine driving condition.

The correction portion 7e may correct the electric supply period “TS” in succeeding fuel injections based on the correction amount “Te”. The correction portion 7e may correct the electric supply period TS for the next fuel injection based on the correction amount “Te” obtained in a previous fuel injection.

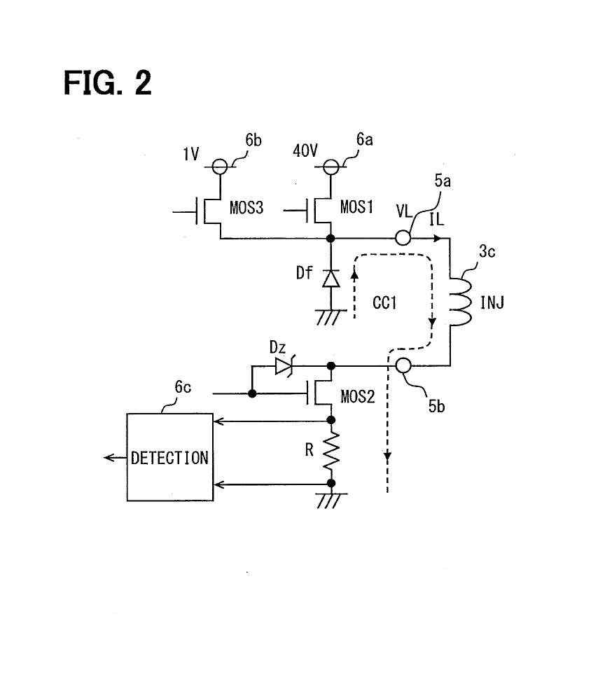

As shown in FIG. 2, the drive circuit 6 is provided with a MOS1 between the high voltage supply 6a and the plus terminal 5a. The MOS1 functions as a high side switch. A MOS2 is provided between the minus terminal 5b and the earth potential The MOS2 functions as a low side switch. A MOS3 is provided between the low voltage supply 6b and the plus terminal 5a. The MOS3 functions as a high side switch for supplying the bias voltage. Therefore, the electric power can be supplied to the coil 3c from the high voltage supply 6a or the low voltage supply 6b. The drive circuit 6 can selectively supply the valve-opening voltage (VF1, 40V), the stopping voltage (GND, OPEN, 0V) for closing the fuel injector 3, or the bias voltage (VF2, 1V) to the terminals 5a, 5b.

The drive circuit 6 is provided with a diode “Df” between the terminal 5a and the earth potential. An anode of the diode “Df” is connected to the earth potential and a cathode is connected to the terminal 5a. The diode “Df” closes the closed circuit “CC1” including the coil 3c by counter-electromotive force induced by the coil 3c. The diode “Df” stops supplying electric power to the closed circuit “CC1”, when the high voltage supply 6a supplies electric power to the coil 3c.

A Zener diode “Dz” is provided between a positive electrode of the MOS2 and a gate terminal for self-bias. An anode of the Zener diode “Dz” is connected to the gate terminal. A cathode of the Zener diode “Dz” is connected to the plus terminal of the MOS2. The Zener diode “Dz” turns ON the MOS2, when voltage is supplied to the plus terminal of the MOS2. For example, the MOS2 is turned ON by the counter-electromotive force induced by the coil 3c, and the closed circuit CC1 including the diode “Df” is formed.

According to the above configuration, the valve-open control portion 7b forms the closed circuit “CC1” which permits an energization of the coil 3c after stopping the valve-opening voltage by turning ON the MOS2. Further, the valve-open control portion 7b turns ON the MOS2 and the MOS3 so that a circuit including the low voltage supply 6b for supplying the bias voltage to the terminals 5a, 5b is defined.

A resistor “R” is provided between the MOS2 and the earth potential. The voltage drop in the resistor “R” represents the electric current “IL”. The voltage drop in the resistor “R” is detected by a detection circuit 6c. The detected voltage drop is transmitted to the CPU 7. The detection circuit 6c detects the electric current “IL” by detecting the voltage drop in the resistor “R”. The detection circuit 6c detects the electric current “IL” in such a manner that an inflection point can be identified by mathematical process in the valve-close detecting portion 7c.

The MOS1, the MOS2, and the MOS3 are switching devices. These switching devices are power MOSFET (metal oxide semiconductor field effect transistor). The switching device may be a bipolar transistor, or an IGBT (insulated gate type bipolar transistor).

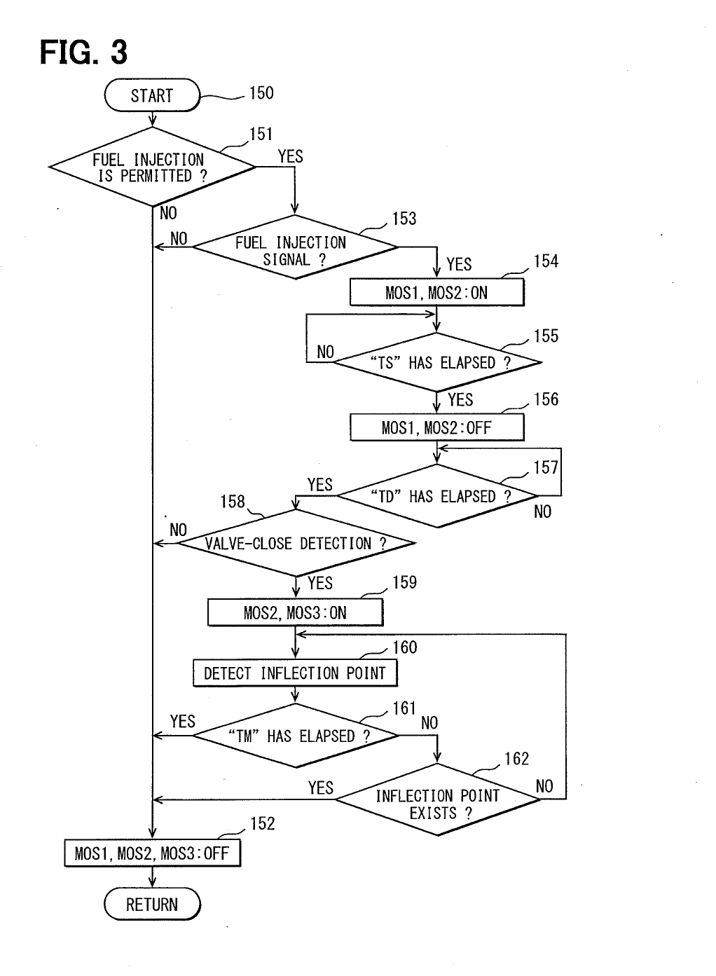

FIG. 3 is a flowchart showing a control processing 150 for controlling the drive circuit 6 to detect an inflection point. This processing is started when the internal combustion engine 2 is started. In step 151, the ECU 5 determines whether a fuel injection by the fuel injector 3 is permitted. For example, the ECUS determines whether the fuel injection is permitted based on an internal flag. When the fuel injection is prohibited in step 151, the procedure proceeds to step 152. In step 152, the ECU 5 turns OFF the MOS1 to the MOS3. As a result, the terminals 5a and 5b are brought into an open condition (OPEN). When the fuel injection is permitted in step 151, the procedure proceeds to step 153.

In step 153, the ECU 5 determines whether a fuel injection signal is generated. When no fuel injection signal is generated, the procedure proceeds to step 152. When the fuel injection signal is generated, the procedure proceeds to step 154.

In step 154, the ECU 5 turns ON the MOS1 and the MOS2. Thereby, the valve-opening voltage “VF1” is supplied to the terminals 5a, 5b. The electric current flows through the coil 3c, and the coil 3c is magnetized. The needle 3b is attracted towards the stator 3a. The fuel injector 3 starts a valve opening action. The needle 3b is gradually lifted up.

In step 155, the ECU 5 determines whether the electric supply period “TS” has elapsed. The electric supply period “TS” is established based on the fuel injection quantity “Q”. During the electric supply period “TS”, an electric power is supplied from the high voltage supply 6a to the coil 3c in order to obtain the small fuel injection quantity “Q”. When the electric supply period “TS” has elapsed, the procedure proceeds to step 156. As a result, the needle 3b is gradually lifted up until the electric supply period “TS” has elapsed. The fuel injector 3 is gradually opened and the fuel injection quantity is gradually increased.

In step 156, the ECU 5 turns OFF the MOS1 and the MOS2. Thereby, the supply of valve-opening voltage is terminated. The magnetization of the coil 3c is also terminated. The needle 3b stops the movement in the valve-open direction and then starts to be apart from the stator 3a. That is, the fuel injector 3 starts a valve closing operation before being fully opened. The lift amount of the needle 3b decreases gradually.

When the MOS1 and the MOS2 are turned OFF, a stop circuit is generated between the terminals 5a, 5b so that the fuel injector 3 stops fuel injection. Between the time t2 and the time t3, the terminals 5a, 5b are set to the open condition (OPEN). In this case, the voltage supplied to the terminals 5a, 5b is an open voltage level (OPEN). This voltage level is also the voltage for closing the fuel injector 3. This voltage level is stopping voltage.

In step 157, the ECU 5 determines whether a delay period “TD” has elapsed. When the delay period “TD” has elapsed, the procedure proceeds to step 158. As a result, until the delay period “TD” has passed, both ends of the coil 3c are set to the open condition.

When a supply of the valve-opening voltage to the coil 3c is stopped in step 156, the counter-electromotive force is generated in the coil 3c by its self induction. The delay period “TD” is established in such a manner as to include a peak of the flyback voltage which appears between both terminals of the coil 3c by the counter-electromotive force. The delay period “TD” is established in such a manner as to expire when the flyback voltage decreases by a predetermined quantity. By opening the both end terminals of the coil 3c over the delay period “TD”, the attenuation of the residual magnetism energy of the coil 3c can be promoted. The delay period “TD” is 100 microseconds, for example.

When the CPU 7 does not turn OFF the MOS2 compulsorily, it is likely that the MOS2 is biased by the counter-electromotive force to be turned ON in a period where the flyback voltage brakes down the Zener diode “Dz”. For this reason, the closed circuit “CC1” absorbs the serge due to the flyback.

In step 158, the ECU 5 determines whether a valve-close detecting processing is performed. The valve-close detecting processing is performed when the internal combustion engine 2 is in a driving condition suitable for the valve-close detecting processing. When no valve-close detecting processing is performed, the procedure proceeds to step 152. When the valve-close detecting processing is performed, the procedure proceeds to step 159.

In step 159, the ECU 5 turns ON the MOS2 and the MOS3. Thereby, the bias voltage “VF2” is supplied to the terminals 5a, 5b from the low voltage supply 6b.

In step 160, the ECU 5 detects the inflection point on a waveform of reverse voltage “Ve” induced by the coil 3c or the electric current “IL” flowing through the coil 3c. The ECU5 performs a computing process for detecting the inflection point of electric current IL detected by the detecting circuit 6c. The inflection point appears in a predetermined period after the supply of the valve-opening voltage is terminated. Therefore, a detection window of predetermined period width can be used in step 160.

In step 161, the ECU5 determines whether a detection period “TM” has passed. In the detection period “TM”, an inflection point can be observed on the waveform of the electric current “IL”. The detection period “TM” is set after the supply of the valve-opening voltage is terminated. When the detection period “TM” has elapsed, the procedure proceeds to step 152. When the detection period “TM” has not elapsed, the procedure proceeds to step 162.

In step 162, the ECU 5 determines whether the inflection point has been detected in step 160. When the inflection point has been detected in step 160, the procedure proceeds to step 152. When the inflection point has not been detected in step 160, the ECU 5 repeats steps 160 to 162. Therefore, the bias voltage can be supplied during the detection period “TM”. However, when the inflection point is detected on the waveform of the electric current “IL”, the supply of the bias voltage is terminated before the detection period “TM” expires.

The valve-open control portion 7b controls the drive circuit 6 in such a manner as to terminate the supply of the valve-opening voltage before the fuel injector 3 is fully opened. The open valve control for small injection is executed in steps 154 to 156. The bias-control portion 7f corresponds to the processing in steps 159 and 152. The bias-control portion 7f controls the drive circuit 6 in such a manner as to supply the bias voltage after the valve-open control portion 7b terminates the supply of the valve-opening voltage. After the fuel injector 3 is fully opened, the supply of the bias voltage is terminated. Furthermore, the bias-control portion 7f controls the drive circuit 6 to supply the stopping voltage, after terminating the supply of the bias voltage.

Furthermore, the processing in step 157 corresponds to a stop-control portion. After the valve-open control portion 7b terminates the supply of the valve-opening voltage, the stop-control portion supplies the stopping voltage in the delay period “TD” before the bias voltage is supplied by the bias-control portion 7f. The stopping voltage is zero volt.

The correction-amount computing portion 7d and the correction portion 7e perform a correction processing. In this correction processing, the electric supply period “TS” for a succeeding fuel injection is corrected so that the small injection quantity can be correctly obtained.

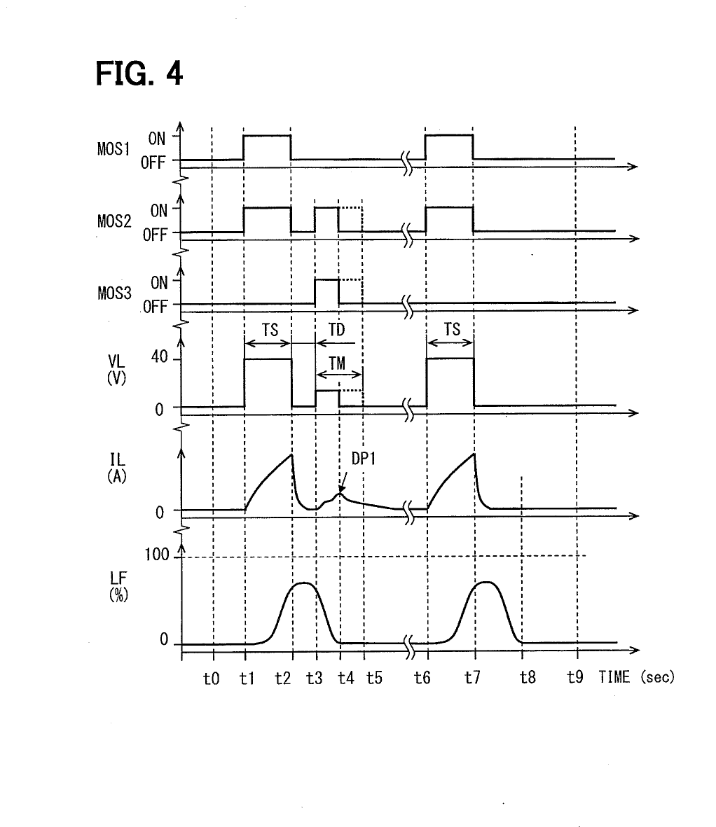

FIG. 4 is a time chart showing an operation of the present embodiment. “VL” denotes the voltage at a plus terminal of the coil 3c, “IL” denotes the electric current flowing through the coil 3c, and “LF” denotes the lift amount of the needle 3b. FIG. 4 illustrates that two small fuel injections are performed. The waveforms of “t1” to “t6” show the case where the bias voltage is supplied. That is, the waveforms of “t1” to “t6” show the case where the inflection point is detected (step 160). The waveforms of “t6” to “t9” shows the case where no bias voltage is supplied.

At the time “t0”, a fuel injection is permitted. At the time “t9”, the fuel injection is prohibited. While the engine 2 is running, the fuel injection is permitted.

At the time “t1”, the voltage is supplied to the coil 3c. In electric supply period “TS” from “t1” to “t2”, the voltage “VL” is “VF1”. The electric current “IL” is gradually increased. After the time “t1”, the lift amount “LF” of the needle 3b starts increasing.

In a case of small injection quantity, the electric supply period “TS” elapses before the fuel injector 3 is positioned at the full-open position. In FIG. 4, the electric supply period “TS” expires at the time “t2”. At the time “t2”, the valve-opening voltage is stopped to be supplied to the coil 3c. The electric current “IL” decreases quickly. The residual magnetism energy of the coil 3c is decreased quickly. The lift amount “LF” decreases gradually.

When the fuel injector 3 is fully closed, the voltage supplied to the terminals 5a, 5b is changed from the bias voltage to the stopping voltage. After the fuel injector 3 is fully closed, the voltage applied to the coil 3c is changed to the stopping voltage.

The delay period “TD” is a time period between the time “t2” and the time “t3”. At the time “t3”, the MOS2 and the MOS3 are turned ON and the bias voltage is supplied to the terminals 5a, 5b.

The lift amount “LF” returns to 0% at the time “t4”. That is, at the time “t4”, the fuel injector 3 is fully closed. At the time “t4”, an inflection point “DP1” appears on a waveform of the electric current “IL”. According to the present embodiment, the inflection point “DP1” is detected by differentiating the waveform of electric current “IL” of when the bias voltage as the valve-closing voltage is supplied to the terminals 5a, 5b.

When inflection point DP1 is detected as a valve-closing time at the time “t4”, the MOS2 and the MOS3 are turned OFF. That is, when the inflection point “DP1” is detected on the waveform of the electric current “IL”, the supply of the bias voltage is terminated before the detection period “TM” expires.

As shown by dashed lines, the bias voltage can be supplied during the detection period “TM”. In this case, at the time “t5”, the MOS2 and the MOS3 are turned OFF.

When the bias voltage is not supplied, the waveform of electric current IL is flat during a period between the time “t7” and the time “t9”.

According to the present embodiment, the small injection quantity can be obtained by stopping the valve-opening voltage before the fuel injector 3 is positioned at the full-open position. Also, even in this case, an actual valve-closing time can be detected. By detecting the actual valve-closing time, it can be confirmed that the fuel injector 3 is opened to inject the small injection quantity. Moreover, the actual valve-closing time can be used for obtaining the small injection quantity in succeeding fuel injection. As the result, the small injection quantity can be correctly injected.

### Second Embodiment

In the first embodiment, after stopping the supply of the valve-opening voltage, the terminals 5a and 5b are in open condition (OPEN) during the delay period “TD”. However, without providing the delay period “TD”, the bias voltage may be supplied instead of the valve-opening voltage.

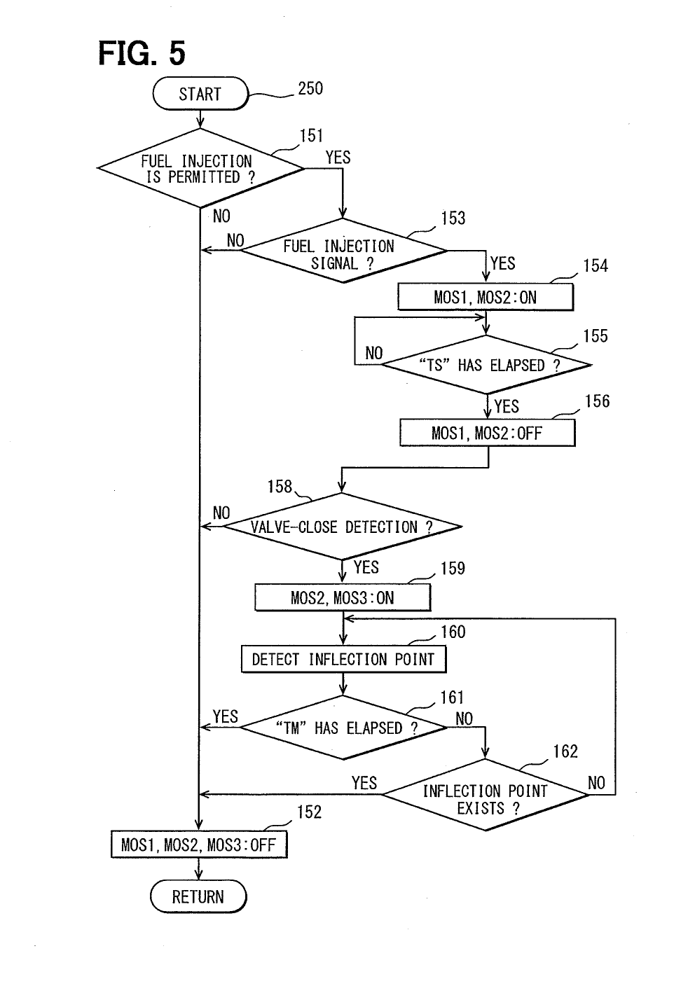

FIG. 5 is a flowchart showing a control processing 250 which the ECU executes. The same processes as those in the first embodiment are indicated with the same reference numerals. The control processing 250 does not have step 157. Thereby, the voltage supplied to the terminals 5a, 5b is directly changed from a valve-opening voltage to the bias voltage, without providing the delay period TD.

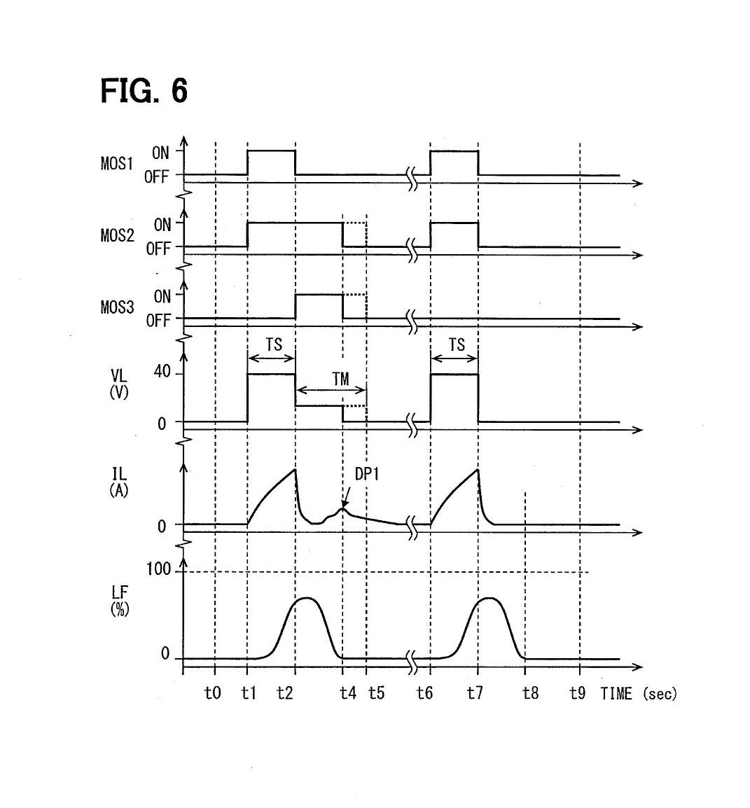

As shown in FIG. 6, immediately after the electric supply period “TS”, the detection period “TM” is started without the delay period “TD”. In this embodiment, the valve-opening voltage is stopped at the time “t2”. After the valve-opening voltage is stopped, the bias voltage is supplied as a valve-closing voltage instead of a valve-opening voltage. The fuel injector 3 receives the bias voltage and is driven in a valve closing direction. When the lift amount “LF” becomes 0% at the time “t4”, an inflection point “DP1” appears on the waveform of the electric current “IL”. This inflection point “DP1” is detected as the valve-closing time. At the time “t4”, the supply of the bias voltage is terminated. After the supply of the bias voltage is terminated, the voltage equivalent to the open condition is supplied to the terminals 5a, 5b as the stopping voltage instead of the bias voltage.

According to the present embodiment, the actual valve-closing time of the fuel injector 3 can be detected, without providing the delay period “TD”.

### Third Embodiment

In the above embodiments, it is determined whether the inflection point detection is performed with respect to each fuel injection. In the present embodiment, with respect to all small fuel injection, the inflection point may be detected.

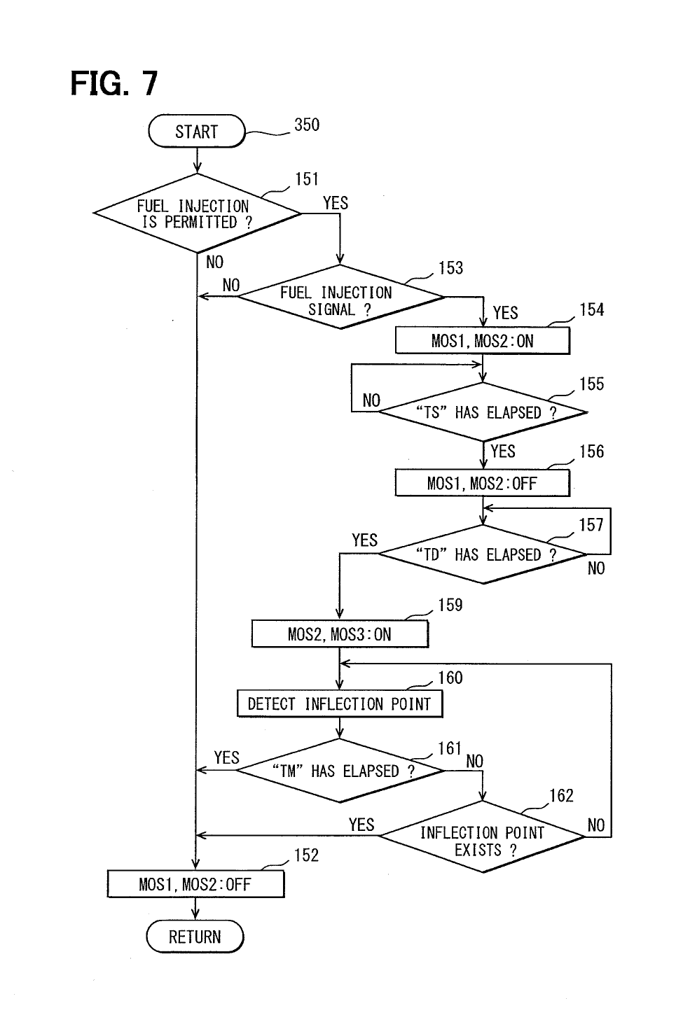

FIG. 7 is a flowchart showing a control processing 350 which the ECU 5 executes. The same processes as those in the above embodiments are indicated with the same reference numerals. In step 159, the bias voltage is supplied with respect to all small fuel injections. In step 160, the inflection point is detected with respect to all small fuel injections.

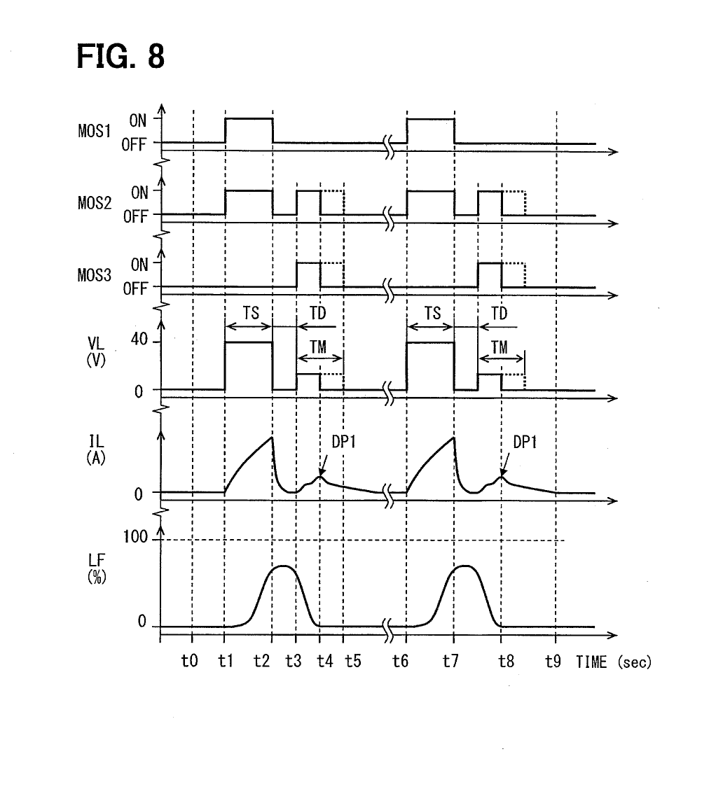

As shown in FIG. 8, the inflection point “DP1” can be observed in all small fuel injections.

### Fourth Embodiment

In the above embodiments, only in the detection period “TM”, the bias voltage is supplied to the terminals 5a, 5b. According to the present embodiment, the bias voltage may be supplied to the terminals 5a, 5b during a period when the fuel injector 3 is operated.

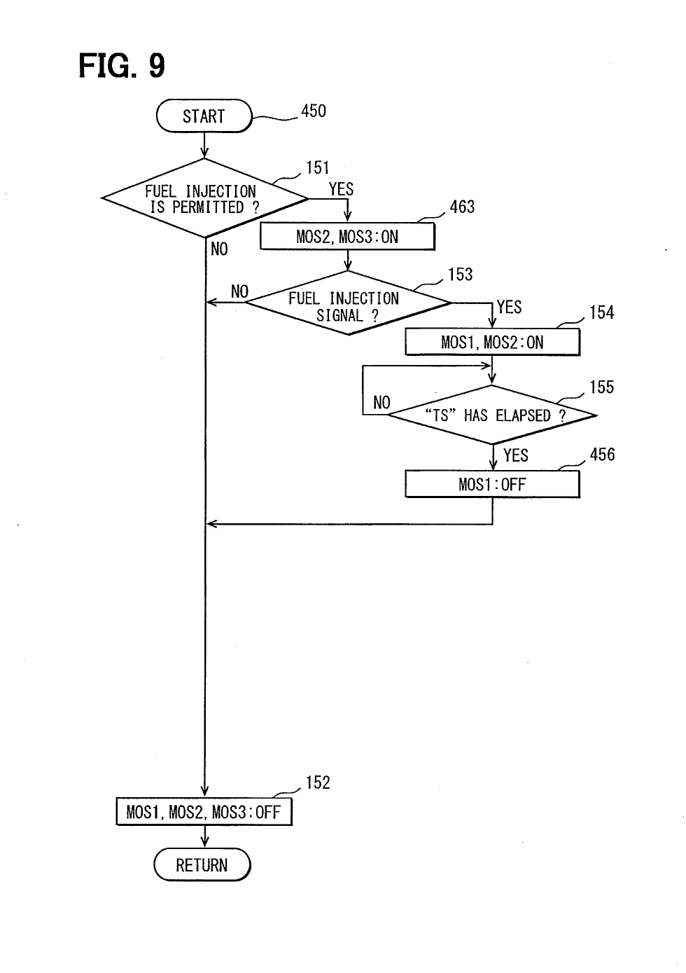

FIG. 9 is a flowchart showing a control processing 450 which the ECU 5 executes. The same processes as those in the above embodiments are indicated with the same reference numerals. In step 463, the ECU 5 turns ON the MOS2 and the MOS3. In step 456, the ECU 5 turns OFF the MOS1. Thus, during a period in which a fuel injection is permitted, the bias voltage is continuously supplied to the fuel injector 3.

The valve-open control portion 7b controls the drive circuit 6 in such a manner as to terminate the supply of the valve-opening voltage before the fuel injector 3 is fully opened. The bias-control portion 7f corresponds to the processing in steps 463 and 152. The bias-control portion 7f controls the drive circuit 6 to supply the bias voltage only while the fuel injection is permitted.

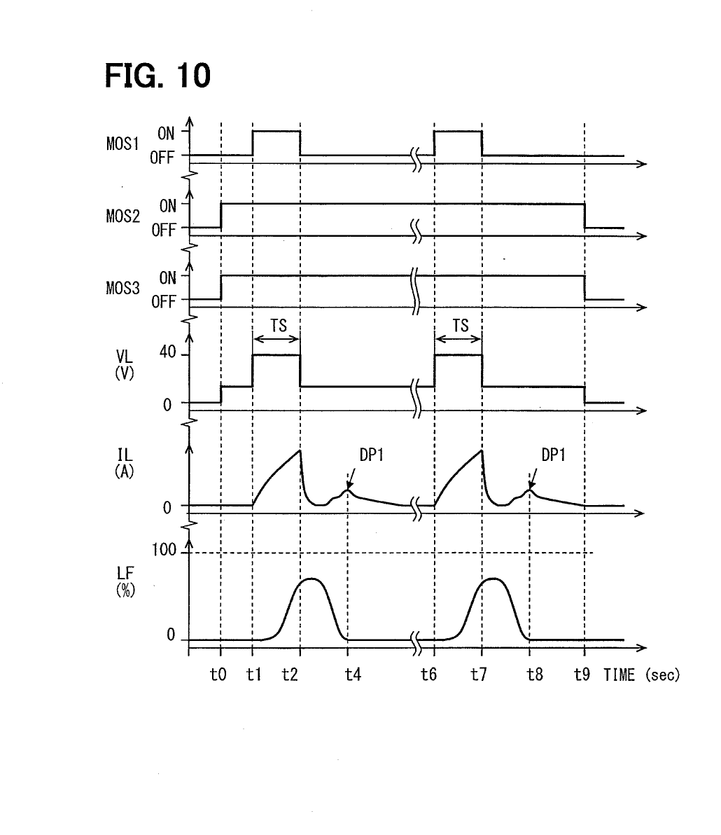

As shown in FIG. 10, at the time “t0”, the MOS2 and the MOS3 are turned ON. The MOS2 and the MOS3 are maintained ON until the time “t9”. That is, the bias voltage is continuously supplied during the period in which the fuel injector 3 is operated. In this case, the inflection point “DP1” appears in all fuel injections.

In this embodiment, the voltage supplied to the terminals 5a and 5b is switched to the bias voltage from the valve-opening voltage before the fuel injector 3 is fully opened. Furthermore, the voltage supplied to the terminals 5a and 5b is changed from the bias voltage to zero volt after the fuel injector 3 is closed multiple times.

### Fifth Embodiment

In the above embodiments, when the bias voltage is supplied to the terminals 5a, 5b, the inflection point DP1 is appeared. However, even when no bias voltage is supplied, an inflection point “DP2” appears.

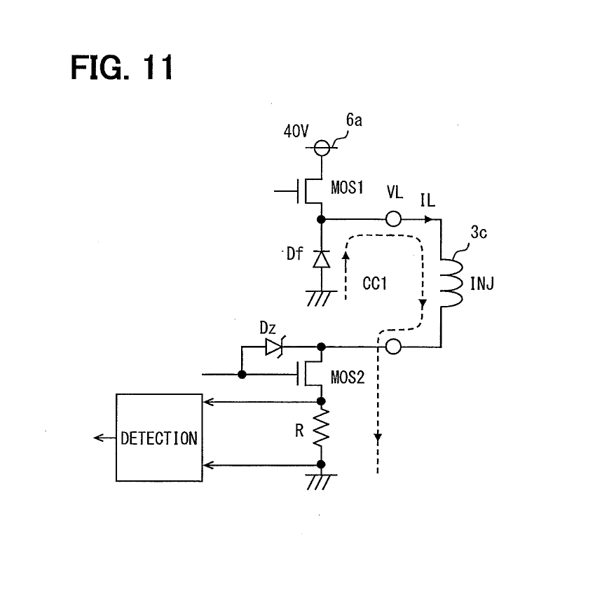

FIG. 11 shows a drive circuit 6 which has no low voltage supply. When the MOS1 is turned OFF and the MOS2 is turned ON, the electric current “IL” flows in the closed circuit “CC1”. On a waveform of the electric current “IL”, the inflection point “DP2” appears due to a variation in inductance of when fuel injector 3 is fully opened. The valve-open control portion 7b forms the closed circuit “CC1” which permits an energization of the coil 3c after stopping the valve-opening voltage by turning ON the MOS2.

The drive circuit 6 can selectively supply the valve-opening voltage “VF1” or the stopping voltage (GND, OPEN) to the terminals 5a, 5b.

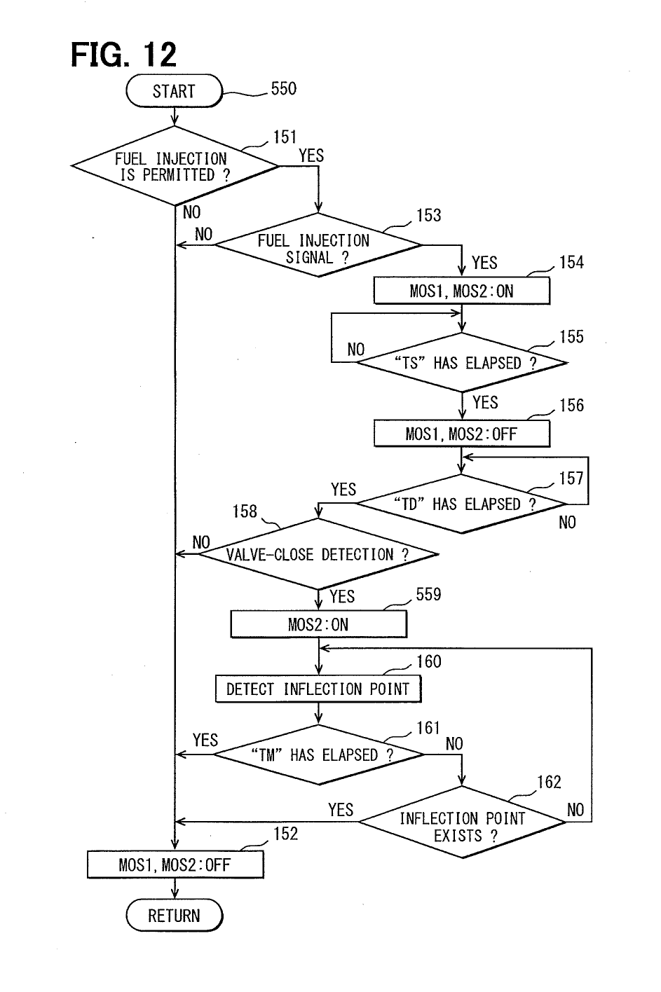

FIG. 12 is a flowchart showing a control processing 550 which the ECU 5 executes. The same processes as those in the first embodiment are indicated with the same reference numerals. In step 559, the MOS2 is turned ON and the closed circuit “CC1” is closed. As a result, even after the supply of the valve-opening voltage is terminated, the electric current IL can be observed.

The valve-open control portion 7b controls the drive circuit 6 in such a manner as to terminate the supply of the valve-opening voltage before the fuel injector 3 is fully opened. Furthermore, the valve-open control portion 7b controls the drive circuit 6 to supply the stopping voltage, after terminating the supply of the valve-opening voltage. The valve-open control portion 7b includes an open part and a short-circuit part for supplying the stopping voltage to the terminals 5a, 5b. In step 156, the open part opens the terminals 5a, 5b (OPEN). The closed circuit “CC1” is opened to supply the stopping voltage to the terminals 5a, 5b. In step 559, the short-circuit part switches the terminals 5a and 5b to the short circuit condition (GND). The closed circuit “CC1” is closed to supply the stopping voltage to the terminals 5a, 5b. The waveform of the electric current “IL” can be observed.

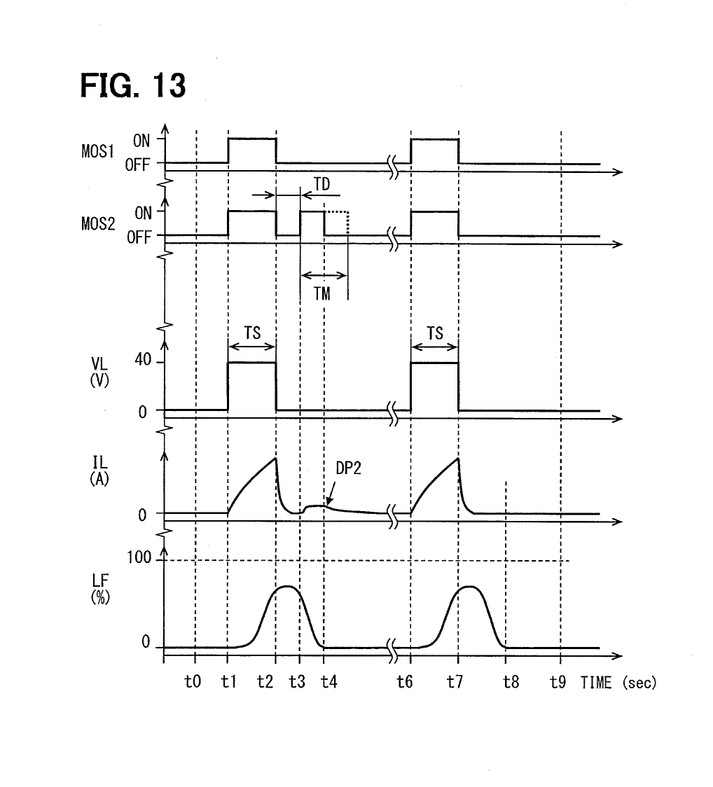

As shown in FIG. 13, the MOS2 is turned ON after the delay period “TD” elapsed. Inflection point DP2 appears in the waveform of electric current IL which flows into closed circuit CC1. According to the present embodiment, the inflection point “DP2” is detected by differentiating the waveform of electric current “IL” of when the valve-closing voltage is supplied to the terminals 5a, 5b. When the inflection point “DP2” is detected at “t4”, the MOS2 is turned OFF.

According to the present embodiment, the valve-closing time of the fuel injector 3 can be detected, without supplying the bias voltage.

### Sixth Embodiment

An inflection point on a waveform of the voltage applied the terminal 5a, 5b may be detected to detect a valve-closing.

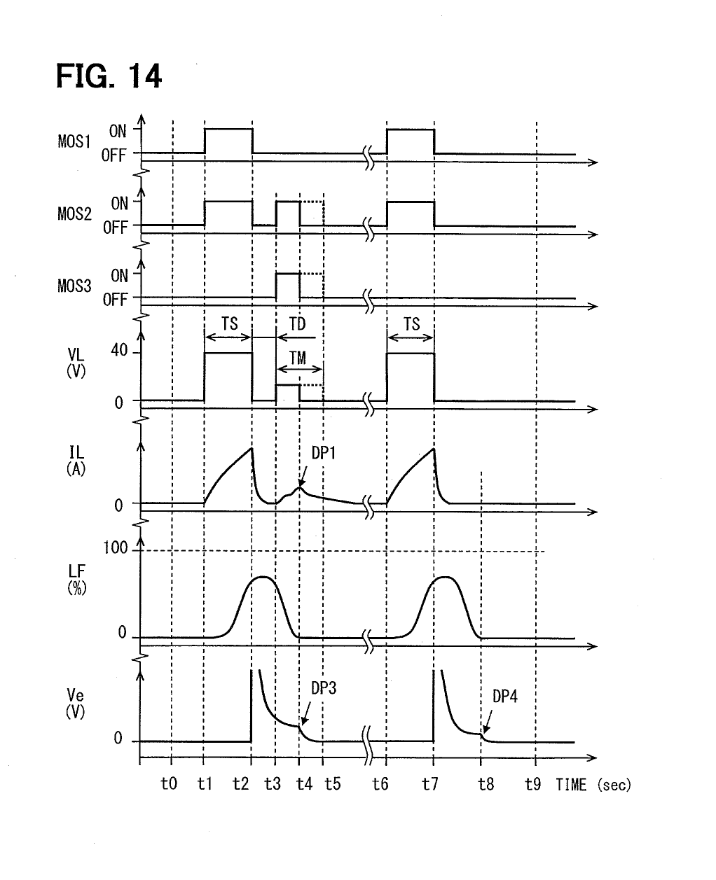

FIG. 14 shows a waveform of the reverse voltage “Ve” induced by the coil 3c. At the time “t4”, an inflection point “DP3” appears on a waveform of the reverse voltage “Ve”. Even when the bias voltage is not supplied, an inflection point “DP4” is observed at the time “t8”. It can be detected that the fuel injector 3 is fully closed.

### Other Embodiment

The preferred embodiments are described above. The present disclosure is not limited to the above embodiment.

For example, the control units can be configured by software, hardware or a combination thereof. Also, the control unit can be configured by an analog circuit.

When the fuel injector 3 is fully closed, the voltage supplied to the terminals 5a, 5b is switched to the stopping voltage. Alternatively, the coil 3c may be short-circuited or grounded.

Moreover, the reverse voltage may be supplied immediately after the electric supply period “TS”. The reverse voltage promotes attenuation of the magnetic energy remaining in the coil 3c.

Moreover, the voltage values of the high voltage supply 6a and the low voltage supply 6b can be changed. For example, the valve-opening voltage which the high voltage supply 6a supplies may be +12V. The bias voltage can be set to +5V.

What is claimed is:

1. A fuel injection controller which has terminals connectable to a coil of a fuel injector, comprising:
a valve-open control portion which supplies a valve-opening voltage to the terminals for opening the fuel injector and terminates the supply of the valve-opening voltage before the fuel injector is fully opened; and
a valve-close detecting portion which detects that the fuel injector is fully closed by detecting an inflection point on a waveform of an electric current flowing through the coil or an inflection point on a waveform of a voltage applied to the terminals.

2. A fuel injection controller according to claim 1, wherein
the valve-close detecting portion identifies a valve-closing time at which the fuel injector is positioned at a full-open position,
the fuel injection controller further comprising:
a correction processing portion correcting a parameter in succeeding fuel injection so that an error of the fuel injection quantity resulting from an error of the valve-closing time in succeeding fuel injection and the target valve-closing time is decreased based on a valve-closing time detected in the preceding fuel injection.

3. A fuel injection controller according to claim 2, wherein
the correction processing portion corrects a valve-opening voltage supply period in a succeeding fuel injection based on a valve-opening period in preceding fuel injection.

4. A fuel injection controller according to claim 2, wherein
the correction processing portion corrects a valve-opening voltage supply period in a succeeding fuel injection based on a valve-close-delay period in preceding fuel injection.

5. A fuel injection controller according to claim 1, further comprising:
a drive circuit selectively supplying the valve-opening voltage, a stopping voltage for closing the fuel injector, or a bias voltage of which voltage value is between the valve-opening voltage and the stopping voltage; and
a bias-control portion controlling the drive circuit in such a manner as to supply the bias voltage after the valve-open control portion terminates the supply of the valve-opening voltage and terminate a supply of the bias voltage after the fuel injector 3 is fully closed.

6. A fuel injection controller according to claim 5, further comprising:
a stop-control portion supplying a stopping voltage in a specified delay period of before a supply of the bias voltage.

7. A fuel injection controller according to claim 1, wherein
a drive circuit selectively supplying the valve-opening voltage, a stopping voltage for closing the fuel injector, or a bias voltage of which voltage value is between the valve-opening voltage and the stopping voltage; and
a bias-control portion controlling the drive circuit in such a manner as to supply the bias voltage only while a fuel injection is permitted.

8. A fuel injection controller according to claim 1, further comprising:
a drive circuit selectively supplying the valve-opening voltage, or a stopping voltage for closing the fuel injector, wherein
the valve-open control portion controls the drive circuit in such a manner as to terminate the supply of the valve-opening voltage before the fuel injector is fully opened, and
the valve-open control portion controls the drive circuit in such a manner as to supply a stopping voltage instead of the valve-opening voltage.

9. A fuel injection controller according to claim 1, wherein
the valve-open control portion forms a closed circuit which energizes the coil after a supply of the valve-opening voltage is terminated.

10. A fuel injection controller according to claim 1, wherein
the valve-close detecting portion detects the inflection point by a differentiation processing and/or an integration processing.
